(19) United States
(12) Patent Application Publication
(10) Pub. No.: US 2021/0321014 A1
(43) Pub. Date: Oct. 14, 2021

(54) ENTITY ACCOUNT BASED VERSIONS

(71) Applicant: Hewlett-Packard Development Company, L.P., Spring, TX (US)

(72) Inventors: Felipe Silveira, Barueri (BR); Gabriela Matias Navarro, Barueri (BR); Simone Hanazumi, Barueri (BR)

(73) Assignee: Hewlett-Packard Development Company, L.P., Spring, TX (US)

(21) Appl. No.: 17/267,517

(22) PCT Filed: Nov. 15, 2018
(86) PCT No.: PCT/US2018/061338

§ 371 Date: Feb. 10, 2021

(51) Int. Cl. H04N 1/32; G06F 40/295; G06F 16/9035; G06N 20/00; H04N 1/00; G06F 3/12

(52) U.S. Cl. CPC H04N 1/32128; G06F 40/295; G06F 16/9035; G06F 3/1243; H04N 1/00212; G06F 3/1204; G06N 20/00

(57) ABSTRACT

Example implementations relate to a non-transitory machine-readable medium including instructions executable by a processing resource. The processing resource can execute the instructions to identify an entity account associated with a correspondence. Responsive to identifying the entity account, the processing resource can execute instructions to determine a profile from a plurality of profiles based on the entity account, wherein the plurality of profiles include details for printing different versions of the correspondence. Subsequent to determining the profile, the processing resource can execute instructions to print a version of the correspondence based on the profile.

### BACKAROUND

Correspondences exchanged between parties can include messages, tickets, photos, coupons, and a variety of other communications. Correspondences can be exchanged electronically through emails, social media, and a variety of other ways to communicate.

### BRIEF DESCRIPTION OF THE DRAWINGS

FIG. 1 illustrates an example non-transitory machine-readable medium consistent with the disclosure.

FIG. 2 illustrates an example of a system consistent with the disclosure.

FIG. 3 illustrates an example flow diagram of a method consistent with the disclosure.

FIG. 4 illustrates a diagram of an example of a system including a first entity, a second entity, a correspondence, a computing device, and a database consistent with the disclosure.

FIG. 5 illustrates a diagram of an example of a system including a first entity, a second entity, a correspondence, a computing device, and a database consistent with the disclosure.

FIG. 6 illustrates a diagram of an example of a system including an entity, a computing device, an entity account, and a database consistent with the disclosure.

FIG. 7 illustrates a diagram of an example of a system including an entity, a computing device, an entity account, and a database consistent with the disclosure.

FIG. 8 illustrates a diagram of an example of a first print profile and a second print profile consistent with the disclosure.

### DETAILED DESCRIPTION

As digital correspondences become more popular, time and energy to attend to each and every correspondence is becoming rarer. For example, responsive to purchasing a plane ticket via a computing device, multiple correspondences may be sorted to identify a correspondence from a plane ticket provider that includes a boarding pass as an attachment. As another example, responsive to receiving an email detailing groceries to buy and responsive to the inaccessibility of email when at a grocery store, an emailed grocery list may not get fulfilled.

Examples described herein relate to a computing device identifying an entity account that determines a print profile to address a correspondence. As used herein, the entity account refers to a collection of data concerning an entity. The entity account can be utilized to gain profile data included in the print profile. The computing device can act without additional interactions from either entity. In other words, when an entity receives an email with a grocery list, a processing resource on an associated computing device can send instructions to a printing device to print a tangible version of the grocery list. The processing resource can act without any input or interaction from the entity.

Details of the printing can be included in print profiles. Print profiles can be utilized to print versions of correspondences. Versions of the correspondences can include tangible versions and digital versions. In addition to printing versions of the correspondences, the entity account based print profiles can alternatively, or additionally, annotate, save, and/or perform other functions on the correspondences. Furthermore, the print profiles can determine which portions of the correspondences to print, annotate, save, and/or perform the other function on. In some examples, the portions of the correspondences to print can include an email, an attachment, or the email and the attachment. As used herein, unless specified otherwise, the term “print” includes to print, to annotate, to save, to further transmit, and similar other functions.

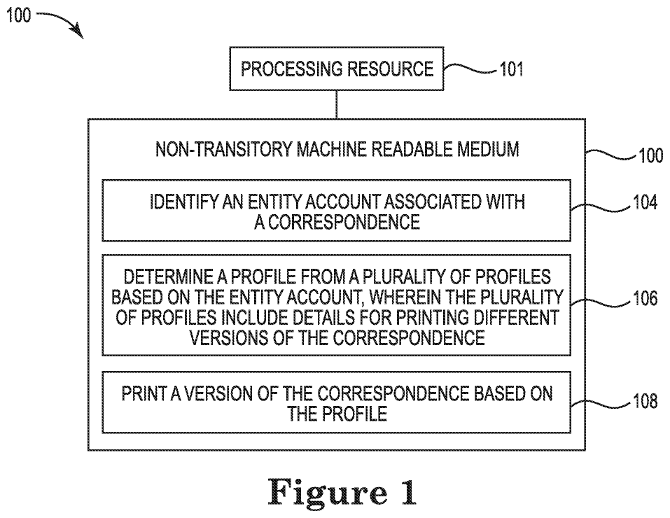

FIG. 1 illustrates an example non-transitory machine-readable medium 100 consistent with the disclosure. A processing resource 101 can execute instructions stored on the non-transitory machine-readable medium 100. The processing resource 101 can be a hardware processing unit such as a microprocessor, application specific instruction set processor, coprocessor, network processor, or similar hardware circuitry that can cause machine-readable instructions to be executed. In some examples, the processing resource 101 can be a plurality of hardware processing units that can cause machine-readable instructions to be executed. The processing resource 101 can include central processor units (CPUs) and/or graphics processing units (GPUs), among other types of processing units. The non-transitory machine-readable medium 100 can be any type of volatile or non-volatile memory or storage, such as random-access memory (RAM), flash memory, read-only memory (ROM), storage volumes, a hard disk, or a combination thereof.

The example medium 100 stores instructions 104 executable by the processing resource 101 to identify an entity account associated with a correspondence. In some examples, the entity account is associated with an entity. The correspondence can be exchanged in that the correspondence can be received by the entity, or, alternatively or additionally, the correspondence can be transmitted by the entity. The correspondence can include a message and/or an attachment. The message and/or the attachment can be a text message, an audio message, a video message, a photography message, or a combination thereof. The correspondence can be exchanged through a variety of ways, including an email, a voicemail, a photograph, a social media account, a phone short message service (SMS), and other forms of media. The correspondence can include a number of attachments in addition to, or instead of, a number of message. In some examples, the correspondence is an email containing the message. In some examples, the correspondence is an email containing the message and the attachment. In some examples, the correspondence is an email containing the attachment. Some examples of what a correspondence can contain are textual files, audio files, video files, image files. The examples can include coupons, order confirmations, invoices, receipts, airline tickets, photos, boarding passes, letters from family, letters from friends, letters from employers, official letters, contracts, voice messages, video messages, and a plethora of other communications.

In some examples, the entity account, as stated above, comprises data concerning the entity. The data can include information related to the entity. The information can be such information as biographic information and/or demographic information about the entity. The biographic information can include such things as age, location, ethnicity, and other similar biographical information. The demographic information can include such things as employer, employment location, job title, educational background, salary, and other similar demographic information.

In some examples, the data concerning the entity can include preferences information of the entity. The preferences information can include such details as whether the entity chooses to print, annotate, save, or perform some other function with the correspondence. The preferences information can include printing preferences provided by the entity. For example, the printing preferences can include whether to print in color, the size of the paper on which to print, and/or other preferences associated with printing. Furthermore, the preferences can include details about a version the entity chooses to print when printing multiple versions is a possibility. In other words, the entity selects to print the version, even though other versions can be printed. For example, the entity has a black and white version of a photograph printed despite a color version being possible. In some examples, the data can include a habit of the entity. As used herein, the habit of the entity describes a tendency of the entity to act a certain way when printing a correspondence. The preferences of the entity can be separate and distinct from the habit of the entity. For example, the data concerning the entity may indicate that the entity would like color versions of the correspondence, but the habit may indicate that the entity has previously printed black and white versions of the correspondence exclusively.

In some examples, the data concerning the entity can include operation information regarding capabilities of output destinations associated with the entity. As used herein, capabilities describes an ability of an output destination to perform a certain function in a particular fashion. In some examples, the capabilities can be provided by a printing device. For example, a printing device can be capable of printing four copies of a correspondence in black and white. Operation information regarding the capabilities of the output destinations associated with the entity can include such details as model names, model numbers, serial numbers, fabrication dates, and other similar details related to printing devices and/or computing devices. In addition, the operation information can include technical information as well, such as failure codes, repair codes, configuration factors, performance scores, and other similar details related to printing devices and/or computing devices. In some examples, the operation information for a digital version of the correspondence can be an equivalent of operation information for a tangible version of the correspondence.

In some examples, the data concerning the entity can include printing information of the entity. As used herein, printing information refers to information concerning the entity that relates to printing. In some examples, the printing information can be provided by the output destinations. The printing information can be based on a number of details collected over a period of time, including printing behavior of the entity, preferences of the entity, capabilities of output destinations associated with the entity, a source document, and other such details. Such details as a source of a request to print, number of pages to be printed, whether color is possible for the printing, resolution of the version to print, ink usage of the printing, and other similar features can also be included in the printing information.

In some examples, the processing resource 101 can execute instructions to analyze the data. The data can be analyzed through a number of ways, including by utilizing a machine learning model or a different learning model. For example, the data can be analyzed utilizing a linear regression model, a conditional decision tree model, and a Bayesian network model, among other possible models that can be used to analyze data. When analyzing the data, the processing resource 101 can execute instructions to store the data in a database on an associated computing device. Additionally, or alternatively, the processing resource 101 can execute instructions to transmit the data to a database on a server. The server can be a local server and/or a cloud server. When the server is a local server, accessibility of the data extends to anywhere from where the local server can be accessed. When the server is a cloud server, accessibility of the data extends to anywhere that can access the cloud server through an internet connection.

Furthermore, when additional input data is received, the processing resource 101 can execute instructions to update the data utilizing the machine learning model. The updated data can be referred to as output data. The update to the data can be stored in a database on the associated device, and/or transmitted to a database on the server, the local server and/or the cloud server. Additional data can be received when there is a change in existing data. The updated data can reflect a modification of the input data, a removal of data from the input data, an additional to the input data, and/or other changes to the input data. The input data can be changed by keeping track of information related to the entity. As stated above, the information related to the entity can include biographic information, demographic information, preferences information, version habit information, operation information, version printing information, and other information related to the entity. As used herein, the term “data” is intended to refer to information concerning the entity that has been collected over a period of time. As such, the input data can be updated utilizing biographic information, demographic information, preferences information, version habit information, operation information, and version printing information to generate the output data.

In some examples, when a change occurs in the information related to the entity, the data can be updated with the additional data. In some examples, the entity can update the data by accessing the database on the server and/or the associated computing device. Furthermore, before any changes to the data are made, the data can be predefined by a manufacturer of the computing device, or another with an ability to set predefined information as data. For example, for a new computing device, the preferences information for an entity can be predefined.

The example medium 100 stores instructions 106 executable by the processing resource 101 to determine a profile from a plurality of profiles based on the entity account. The profile includes profile factors logical propositions (rules), source types, configurations, and destinations. By determining a profile, the profile factors can also be determined, and as such, a version of the correspondence can be printed, annotated, saved, or undergo some other function. In some examples, the plurality of profiles can include details for printing different versions of the correspondence. The different versions of the correspondence can include digital versions and tangible versions. When a version is printed digitally, the version can additionally be printed tangibly, and vice versa. Examples of digital versions include permanent document files (PDFs), images of the correspondence, and other similar digital prints. Examples of tangible versions include copies of the correspondence marked on print media, such as paper, plastic, and other markable media.

When a processing resource 101 utilizes the machine learning model to analyze the data concerning the entity account, the machine learning model can categorize the entity account into certain profiles. In some examples, an entity can be limited to one entity account, but the entity account can be categorized into a plurality of profiles. The profiles can be print profiles that lead to the correspondence being printed a certain way, at a certain time, with a certain device. For example, when a profile is selected based on the categorization of an entity account, the profile can determine to tangibly print a portion of a correspondence, including any attachments, in color by utilizing a specific printing device.

The example medium 100 stores instructions 108 executable by the processing resource 101 to print a version of the correspondence based on the profile. In some examples, data comprised in the entity account can be analyzed together with profile data to determine which version of the correspondence to print. As used herein, the term “profile data” is intended to refer to data that has been processed by the machine learning model.

In some examples, an auxiliary version including content referenced in the correspondence can be printed. As used herein, the term “auxiliary version” includes a version based on content referenced (mentioned) in the correspondence. The content referenced in the correspondence can be independent of the correspondence. In other words, the auxiliary version can be based on content that is mentioned in but not attached to or included in the correspondence. The content referenced in the correspondence can be referenced with language specific enough to identify the content. The content referenced in the correspondence can be attached to the correspondence and/or otherwise be discoverable based on the specific language. The language can comprise a description of the content, a type of the content, a title of the content, and other identifiers. For example, a received email can reference an article by title posted on a website on the internet. When the email is analyzed, the article posted on the website on the internet can be printed as well. In some examples, the referenced content can be stored on a server. When analyzing the email, due to specific language referencing the content, the content can be discovered on the server, and an auxiliary version of the content can be printed.

In some examples, the correspondence can be annotated. An annotation of the correspondence can include adding details regarding the correspondence, including details concerning attachments to the correspondence and/or content referenced in the correspondence. For example, when a correspondence is annotated, details concerning when the correspondence was exchanged, a reason for the correspondence, and information regarding the content of and/or attachment to the correspondence can be added to the annotation.

In some examples, the correspondence can be saved. The correspondence can be saved in a specific format. Examples of formats in which the document can be saved include document files, image files, and other save file formats. When the correspondence is annotated and/or saved, the correspondence can be made accessible through a way that is different than the exchange of the correspondence. For example, when a correspondence is received through a correspondence client and saved with annotations, the correspondence can be accessed through a program not related to the correspondence client and/or the web browser. In some examples, the correspondence can be annotated and/or saved in a memory resource associated with the computing device and/or a server. In some examples, the annotation can be printed with the correspondence. When printed, the annotation can be on the printed version of the correspondence or printed separately with the correspondence.

In some examples, the correspondence can further be tangibly transmitted. The correspondence can be transmitted to the same entity or to a different second entity through a tangible medium. For example, the correspondence can further be transmitted through a facsimile (fax) to the different second entity. In some examples, the correspondence can further be digitally transmitted. For example, the correspondence can be received as an email and further transmitted to the different second entity as a PDF. As stated above, other similar functions that are not disclosed herein can be performed with the correspondence as well or alternatively.

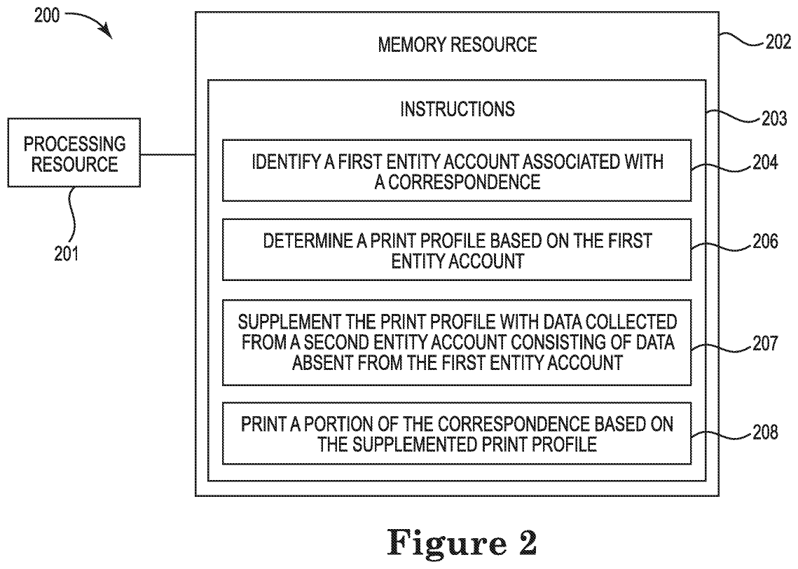

FIG. 2 illustrates an example of a system consistent with the disclosure. As shown in FIG. 2, the system 200 includes a processing resource 201 and a memory resource 202.

The processing resource 201 may be a hardware processing unit such as a microprocessor, application specific instruction set processor, coprocessor, network processor, or similar hardware circuitry that can cause machine-readable instructions to be executed. In some examples, the processing resource 201 may be a plurality of hardware processing units that can cause machine-readable instructions to be executed. The processing resource 201 can include central processing units (CPUs) and/or graphics processing units (GPUs), among other types of processing units. The memory resource 202 may be any type of volatile or non-volatile memory or storage, such as random access memory (RAM), flash memory, read-only memory (ROM), storage volumes, a hard disk, or a combination thereof.

The memory resource 202 may store instructions 203 thereon. When executed by the processing resource 201, the instructions 203 may cause the system 200 to perform specific tasks and/or functions. For example, at block 204, the memory resource 202 may store instructions 203 which may be executed by the processing resource 201 to cause the system 200 to identify a first entity account associated with a correspondence. In some examples, the first entity account can be associated with a first entity. In some examples, the first entity can comprise an individual. In some examples, the first entity can comprise a plurality of individuals. In addition, the correspondence can be received by and/or transmitted by the first entity.

At block 206, the memory resource 202 may store instructions 203 which may be executed by the processing resource 201 to cause the system 200 to determine a print profile based on the first entity account. In the example of FIG. 2, the print profile includes profile factors: a logical proposition factor (rule), a source type factor, a configuration factor, and a destination factor. As used herein, “factor” is intended to refer to a variable that can be used in conjunction with a number of other variables by a processing resource utilizing a machine learning model to determine whether a version of a correspondence should be printed. In addition, the factor can be used to determine the version of the correspondence to be printed. Furthermore, the factor can be used to determine where the correspondence is to be printed, and other details related to the printing itself. For example, based on included profile factors, a profile can be utilized to determine that two copies of a tangible version of a correspondence should be printed by a specific printing device using color ink. In other words, by determining a profile, the profile factors are also determined, and as such, a version of the correspondence can be printed, annotated, saved, or undergo some other function, as determined by the profile factors.

In some examples, the logical proposition factor is composed of sentences generated from data comprised in the entity account. Each logical proposition factor can include a number of correspondence related sentences responsible for triggering the process. For example, a logical proposition factor can read, “The email is a boarding ticket, the printer is connected to the entity computer, and the printer has ink”. Because the sentence includes a correspondence related word (email), the sentence serves as a logical proposition factor, or in other words, as a rule to print.

In some examples, the source type factor comprises a list of possible sources to be printed. The list may include correspondence, attachment, correspondence and attachment, and other similar portions of a correspondence. Because of the source type factor, when a correspondence is analyzed, it can be determined that a portion of the correspondence is to be printed. The portion of the correspondence can comprise an entirety of the correspondence. In other words, the portion can comprise the correspondence, the correspondence and an attachment, or just the attachment to the correspondence.

In some examples, the configuration factor comprises a list of printing preferences and settings that can be used by a computing device. Alternatively, or additionally, the list of printing preferences and settings can be used by an output destination. The list of printing preferences and settings can include a size of print media, a type of print media, color options, a number of copies, quality, and other such configuration settings.

In some examples, the destination factor is a list of output destinations that can be used to print. The list can include tangible printing devices, an option to fax the correspondence, an option to save the correspondence, an option to annotate the correspondence, an option to digitally print the correspondence, and other similar destinations.

Responsive to a change in information the entity account is based on, a processing resource 201 can utilize the machine learning model to reevaluate the print profile. Upon reevaluation, the print profile can be removed from a database or be updated to be current with received additional information. The database can be accessed through a computing device, a local server, and/or a cloud server. The database can also store the entity account.

At block 207, the memory resource 202 may store instructions 203 which may be executed by the processing resource 201 to cause the system 200 to supplement the print profile with profile data collected from a second entity account. The profile data collected from the second entity account can consist of data absent from the first entity account. In other words, when the first entity account is devoid of information related to the profile factors listed above (a logical proposition factor, a source type factor, a configuration factor, and a destination factor), a second entity account can be used to supplement the first entity account. A reason that this can be performed is because print profiles are aggregation groups, based on the categorization of the entity account by the machine learning model. Because the data collected from the entity account and the print profiles are stored in a common database, the processing resource 201 can utilize the machine learning model to fill the gaps in the first entity account's data with profile data collected from the second entity account.

As such, due to the machine learning model's collection and updating of data concerning the entity accounts, when one entity account has missing data, data from another entity account can be used to fill the gap. For example, the first entity account may not have data related to whether a certain correspondence should be printed in color or black and white. As a response, the machine learning model can supplement the print profile with profile data collected from the second entity account.

At block 208, the memory resource 202 may store instructions 203 which may be executed by the processing resource 201 to cause the system 200 to print a portion of the correspondence based on the supplemented print profile. As stated above, the print profile can determine which portion of the correspondence to print. In some examples, data in the first entity account may override the determination of the print profile and instead determine that a different portion of the correspondence should be printed. Furthermore, if the correspondence is to be printed, a version of the printed correspondence can be digital and/or tangible.

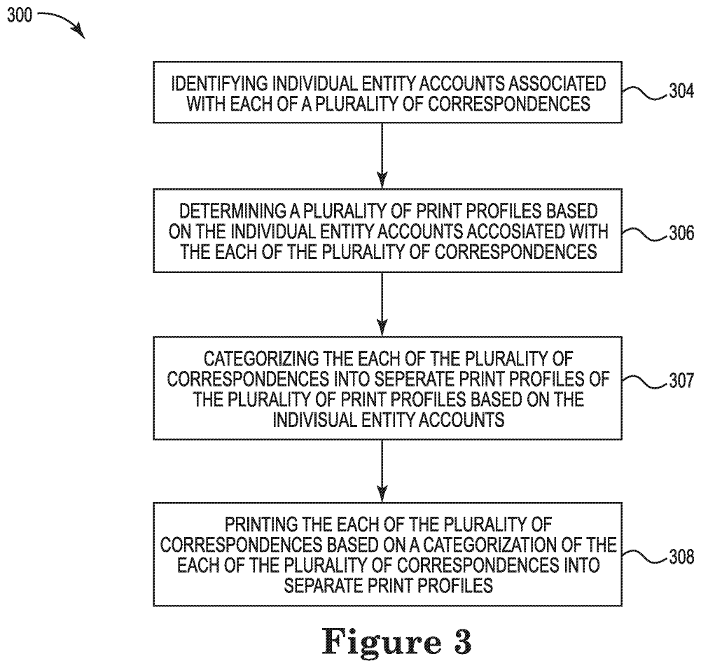

FIG. 3 illustrates an example flow diagram of a method 300 consistent with the disclosure. At block 304, the method can include identifying individual entity accounts associated with each of a plurality of correspondences. In some examples, when there are multiple correspondences received by or transmitted from multiple entity accounts, there can be a number of correspondences which share a receiver and/or a transmitter. In these situations, each of the plurality of correspondences can still be associated with multiple individual entity accounts.

At block 306, the method can include determining a plurality of print profiles based on the individual entity accounts associated with the each of the plurality of correspondences. The determining of the plurality of print profiles can be performed by the processing resource utilizing the machine learning model. The individual entity accounts and the plurality of print profiles can be stored in a database. In other words, due to the data concerning individual entities, included in the individual entity accounts, a plurality of print profiles can be determined.

At block 307, the method can include categorizing the each of the plurality of correspondences into separate print profiles of the plurality of print profiles based on the individual entity accounts. Based on data concerning the entities in the respective individual entity accounts, the plurality of correspondences can be categorized into multiple print profiles. For example, a first entity account can have a print profile that results in the received correspondence being printed in the form of a PDF, whereas a second entity account can have a different print profile that results in the received correspondence being tangibly printed. This difference is a result of the same received correspondence being categorized into different print profiles. In other words, the received correspondence may be categorized into a first print profile for a first number of entity accounts and categorized into a second print profile for a second number of entity accounts. This difference is due to a categorization, performed by a processing resource utilizing the machine learning model, of the plurality of correspondences into separate print profiles based on the details concerning the individual entity accounts.

At block 308, the method can include printing each of the plurality of correspondences based on a categorization of each of the plurality of correspondences into separate print profiles. As stated above, each of the plurality of correspondences can be categorized into certain print profiles based on the individual entity accounts associated with each of the plurality of correspondences. Due to a difference between data concerning entities, the correspondences can be printed in different versions.

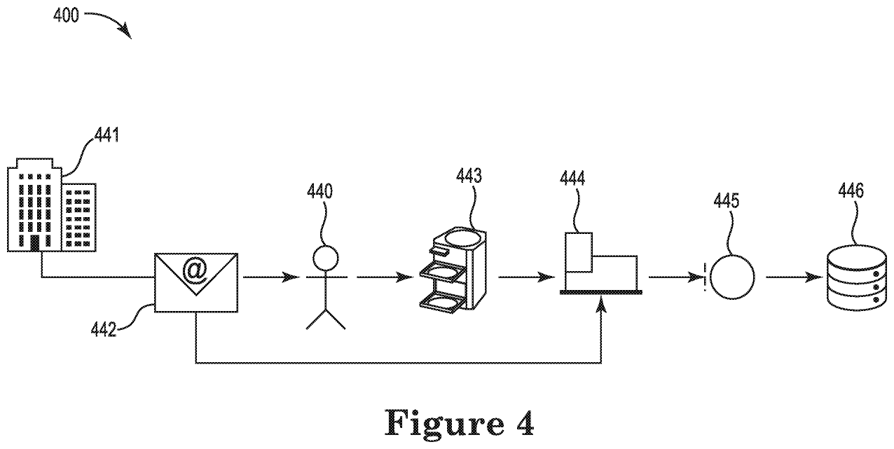

FIG. 4 illustrates a diagram of an example of a system 400 including a first entity 440, a second entity 441, a correspondence 442, a computing device 444, and a database 446. In the example of FIG. 4, the first entity 440 can receive a correspondence 442 from the second entity 441. Alternatively, the first entity 440 can transmit a correspondence 442 to the second entity 441. In other words, an exchange of the correspondence 442 can occur. In some examples, the first entity and the second entity can each be an individual or a plurality of individuals. For example, the first entity can be an individual, and the second entity can be a company of individuals. Furthermore, in some examples, the correspondence 442 can be an email, an email with an attachment, or just an attachment. The attachment can be in the form of photos, videos, music, and other such formats. Upon receipt of the correspondence 442, the first entity 440 can transmit the correspondence to a printing device 443. Output from the printing device can be in the form of a tangible version of the correspondence, a digital version of the correspondence, an annotated version of the correspondence, a saved version of the correspondence, and/or other such output forms.

In some examples, a processing resource associated with a computing device 444 can utilize a machine learning model 445 to analyze the correspondence 442 and usage of the printing device 443. The machine learning model 445 can collect information about the correspondence 442 and the usage of the printing device 443 and transmit the information to a database 446 for storage. The database 446 can include the information transmitted by the processing resource of the computing device 443, as well as data concerning the first entity 440, and data concerning the second entity 441. The database 446 can include data concerning an entity 440 and 441 based on submissions of the data by the entity 440 and 441 to the database 446. The entity 440 and 441 can submit the data by accessing an associated computing device 444 and/or a server, wherein the server can be a local server and/or a cloud server. Alternatively, or additionally, the processing resource associated with the computing device 444 can receive data from the correspondence 442 being analyzed. For example, when the processing resource associated with the computing device 444 detects a change in the data, the data in the database 446 can be updated based on additional data concerning the change in data that is received.

In some examples, the database 446 can receive data about the exchange of the correspondence 442. In some examples, the database 446 can receive data about the usage of the printing device 443. In some examples, the database 446 can store the data about the exchange of the correspondence 442 and the usage of the printing device 443. As a result, due to the database 446 storing data concerning the first entity 440, the second entity 441, the exchange of the correspondence 442, and the usage of the printing device 443, a plurality of entity accounts and a plurality of print profiles can be sustainably stored in the database 446.

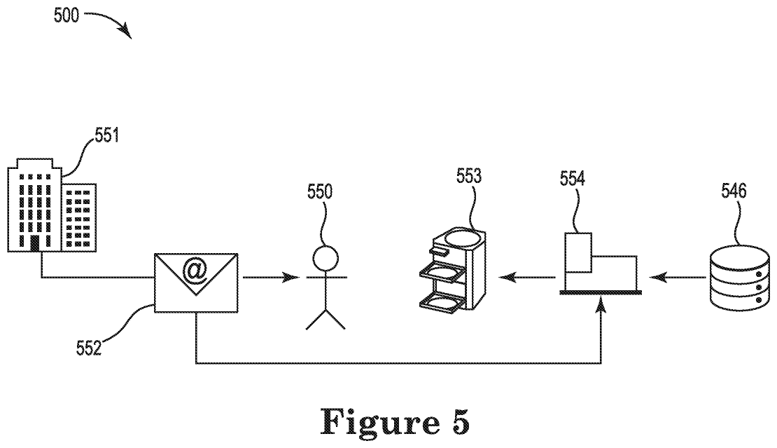

FIG. 5 illustrates a diagram of an example of a system 500 including a first entity 550, a second entity 551, a correspondence 552, a computing device 554, and a database 546. In the example of FIG. 5, a correspondence 552 can be sent from a second entity 551 and received by a first entity 550. In some examples, without further actions from the first entity 550, the correspondence 552 can be detected by a computing device 554. Responsive to the detection, a processing resource associated with the computing device 554 can receive information from a database 546. The information can comprise a print profile based on a first entity account associated with the first entity 550. In some examples, the processing resource 554 can transmit instructions to a printing device 553 to print a version of the correspondence, wherein the version of the correspondence can be printed based on the print profile. In some examples, the print profile can be supplemented by profile data collected from a second entity account associated with the second entity 551.

The print profile can include instructions related to printing the version of the correspondence based on profile factors that comprise the print profile. A logical proposition factor (rule) can be based on sentences generated from the information included in the entity account that concerns the first entity 550. The rule can include a number of correspondence-related sentences. For example, the rule can read, “An email is a boarding ticket, the printer is connected to the entity computer, and the printer has ink.” This rule is satisfied when the correspondence is an email that includes a boarding ticket, the printing device (printer) is connected to the computing device associated with the entity (entity computer), and the printing device has print material (ink). As used herein, “logical proposition” and “rule” are intended to refer to the same factor, unless specified otherwise.

Another factor comprising the print profile, in some examples, can be a source type factor. The source type can be a list of possible sources to be printed. The list can include the email, an attachment, the email and the attachment, and other such types of sources of correspondence.

Another factor comprising the print profile, in some examples, can be a configuration factor. The configuration factor is a list of printing preferences and settings that can be used by the printing device. This list can include such a preference to print in color, to print in black and white, to print as a PDF, to print on a specific paper type, to print a number of copies, to print at a certain quality, and other such values to configure a printing device with.

Another factor comprising the print profile, in some examples, can be a destination factor. The destination factor is an output destination that can be used to print. In other words, the destination factor can be a result of the printing process. For example, the destination factor can be any valid output print destination, including instructions to save the correspondence 552 as a PDF, to fax the correspondence, and other such output destinations.

As such, in the example of FIG. 5, the correspondence 552 is received by the first entity 550. In addition, the example of FIG. 5 displays the computing device 554 detecting a receipt of the correspondence 552, a receipt of profile data from the database 546, and sending instructions to the printing device 553 to print the version of the correspondence. The instructions to print the version of the correspondence 552 can be based on the print profile, wherein the print profile can be based on the profile data. In addition, the example of FIG. 5 displays that the computing device 554 can act without interaction from the first entity 550.

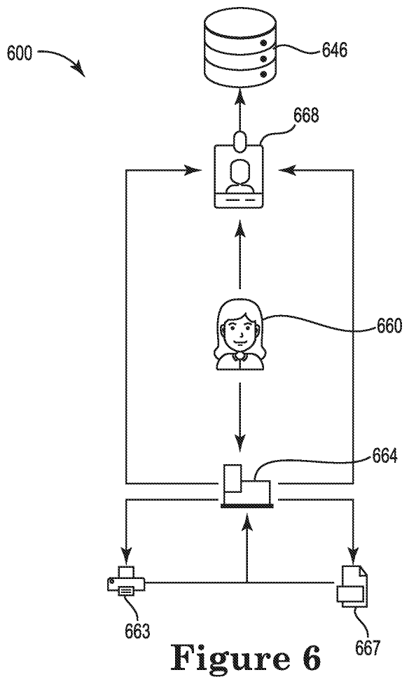

FIG. 6 illustrates a diagram of an example of a system including an entity 660, a computing device 664, an entity account 668, and a database 646. In the example of FIG. 6, a collection of data concerning the entity 660 is displayed. As shown in FIG. 6, when the entity 660 interacts with the computing device 664 to print a tangible version 663 of a document and/or a digital version 667 of the document, information concerning selection choices made by the entity 660 is added to an entity account 668. In some examples, the entity account 668 can be transmitted to a database 646.

In some examples, the selection made by the entity 660 to print the tangible version 663 can include which documents were printed, which documents were correspondences, whether attachments to correspondences were printed as well, which printing device was utilized to perform a printing function, which color options were selected, which resolution was the tangible version 663 printed at, and other such configuration details. In some examples, the selection made by the entity 660 to print the digital version 667 can include which documents were printed, which documents were correspondences, whether attachments to correspondences were printed as well, which printing device was utilized to perform a printing function, which color options were selected, which resolution was the digital version 667 printed at, and other such configuration details.

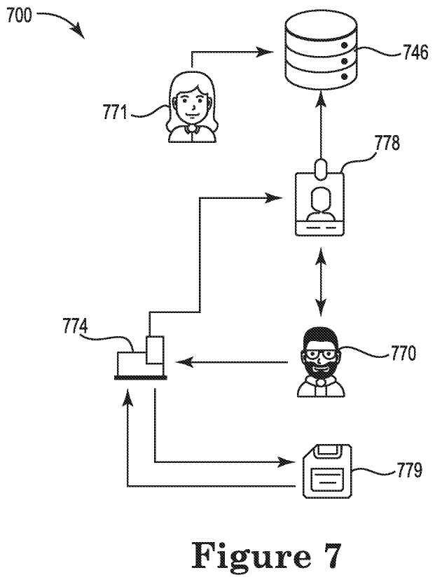

FIG. 7 illustrates a diagram of an example of a system 700 including a first entity 770, a second entity 771, a computing device 774, a first entity account 778, and a database 746. In the example of FIG. 7, when the first entity 770 interacts with the computing device 774 to save 779 a document, selection data is collected and included in the first entity account 778. In some examples, the data stored in the first entity account 778 can be transmitted to the database 746. In addition to the data that is transmitted to the database 746, data can be collected from a second entity 771 and also stored in the database 746. As such, the database 746 becomes a common database.

The data collected on selection choices made by the first entity 770 that is included in the first entity account 778 can be utilized to generate print profiles. In some examples, the print profiles are also transmitted to and stored on the database 746. In some examples, the database 746 includes information from multiple entity accounts associated with multiple entities 770 and 771. This can further result in the database 746 storing multiple print profiles. As a result, when similarities are discovered among entity accounts, print profiles of the first entity 770 can be supplemented with profile data collected from an entity account associated with the second entity 771. For example, when the first entity 770 receives a correspondence including an attachment that can to be printed tangibly, the print profiles of the first entity 770 can falter because the first entity 770 has data of selecting to save documents, including correspondences with attachments. In some examples, the database 746 can provide profile data collected from the second entity 771 to supplement the print profiles of the first entity 770. As a result, because the print profile of the first entity 770 are supplemented with profile data collected from the print profiles of the second entity 771, instructions to tangibly print the correspondence including the attachment can be sent to a printing device.

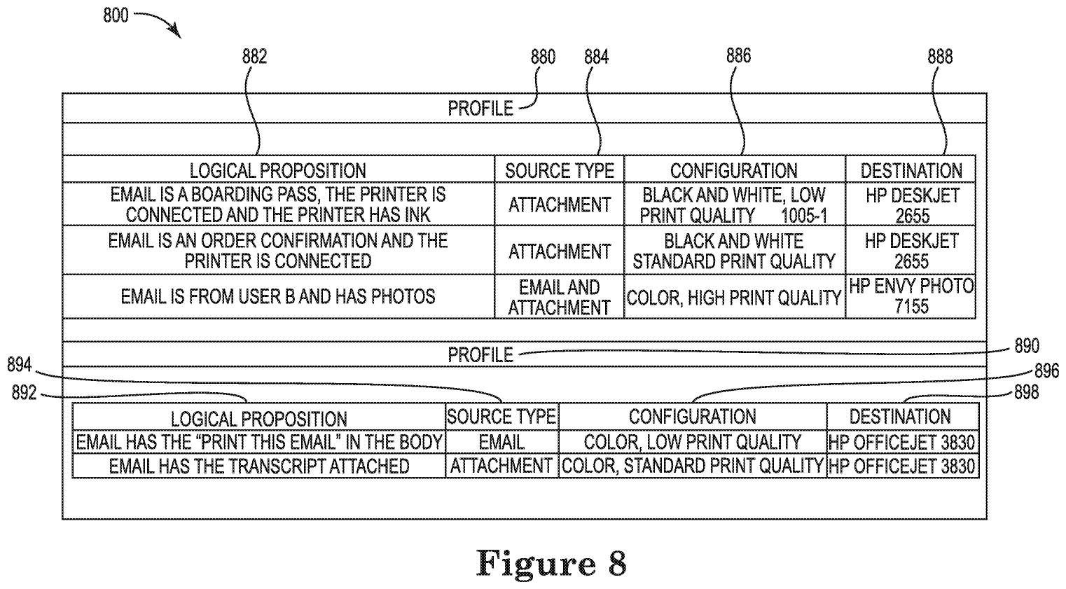

FIG. 8 illustrates a diagram of an example of a first print profile 880 and a second print profile 890. In the example of FIG. 8, the first print profile 880 and the second print profile 890 contain different values for profile factors of a logical proposition (rule) factor 882 and 892, a source type factor 884 and 894, a configuration factor 886 and 896, and a destination factor 888 and 898. These print profiles 880 and 890 are a result of a machine learning model being utilized by a processing resource associated with a computing device.

The machine learning model can be utilized to process information that was collected by the computing device. Based on data transmitted from entity accounts, the machine learning model can categorize correspondences into print profiles. As more data is collected, the more efficient the print profiles can become. In addition, as more data is collected, the more specific the print profiles can become as well. For example, initially, there might be no stored data from the entity accounts. At this point, data that the machine learning model can utilize to categorize correspondences into print profiles can be predefined. A manufacturer, manager, or another with an ability to predefine data can be responsible for predefining data that can be utilized to categorize correspondences. As the machine learning model collects more data subsequent to an initiation, the print profiles can become, as stated above, more efficient. In addition, as stated above, the print profiles can also become more specific as more data is collected.

An increase in collected data can lead to an increased specificity of the profile factors comprising the print profiles 880 and 890. For instance, in some examples, the logical proposition factor 882 and 892 can include a number of correspondence-related sentences. For example, the rule 882 and 892 can read, “An email is a boarding ticket, the printer is connected to the entity computer, and the printer has ink.” This rule 882 and 892 is satisfied when the correspondence is an email that either is or has attached a boarding ticket, the printing device (printer) is connected to the computing device associated with the entity (entity computer), and the printing device has print material (ink). As collected data increases, the correspondence-related sentences can increase as well. Alternatively, or in addition, the correspondence-related sentences can become more specific. As a result, the rule 882 and 892 can become more specific and more efficient.

Another factor comprising the print profiles, in some examples, can be a source type factor 884 and 894. The source type factor 884 and 894 can be a list of possible sources to be printed. The list can include the email, an attachment, the email and the attachment, and other such types of sources of correspondence.

Another factor comprising the print profile, in some examples, can be a configuration factor 886 and 896. The configuration factor 886 and 896 is a list of printing preferences and settings that can be used by the printing device. This list can include such a preference to print in color, to print in black and white, to print as a PDF, to print on a specific paper type, to print a number of copies, to print at a certain quality, and other such values to configure a printing device with.

Another factor comprising the print profile, in some examples, can be a destination factor 888 and 898. The destination factor 888 and 898 is an output destination that can be used to print. In other words, the destination factor 888 and 898 can be a result of the printing process. For example, the destination can be any valid output print destination, including instructions to save the correspondence as a PDF, to fax the correspondence, and other such output destinations.

The above stated examples are non-limiting and are not strictly subject to performance in the order presented in the examples. As such, underlying points presented by the examples can be performed in various other ways, including either at a greater expanse or a further limitation relative to the examples.

In the foregoing detailed description of the disclosure, reference is made to the accompanying drawings that form a part hereof, and in which is shown by way of illustration how examples of the disclosure can be practiced. These examples are described in sufficient detail to enable those of ordinary skill in the art to practice the examples of this disclosure, and it is to be understood that other examples can be utilized and that process, electrical, and/or structural changes can be made without departing from the scope of the disclosure.

What is claimed:

1. A non-transitory machine-readable medium including instructions executable by a processing resource to:
identify an entity account associated with a correspondence;
determine a profile from a plurality of profiles based on the entity account, wherein the plurality of profiles include details for printing different versions of the correspondence; and
print a version of the correspondence based on the profile.

2. The medium of claim 1, wherein the instructions to print the version of the correspondence are further selected from a group consisting of instructions to:
print a digital version of the correspondence; and
print a tangible version of the correspondence.

3. The medium of claim 1, wherein the instructions to print the version of the correspondence are further selected from a group consisting of instructions to:
annotate the version of the correspondence; and
save the version of the correspondence.

4. The medium of claim 1, wherein the entity account comprises data including:
biographic information of an entity;
demographic information of the entity;
preferences information of the entity;
version habit information of the entity;
operation information regarding version capabilities of the entity; and
version printing information of the entity.

5. The medium of claim 4, further comprising instructions executable by the processing resource to analyze data utilizing a machine learning model, wherein the analyzed data is transmitted to a server.

6. The medium of claim 4, further comprising instructions executable by the processing resource to update the entity account by utilizing a machine learning model, wherein the machine learning model updates the entity account when additional data is received.

7. The medium of claim 1, wherein the correspondence is:
a received correspondence; or
a transmitted correspondence.

8. The medium of claim 1, further comprising instructions to print an auxiliary version of content referenced in the correspondence.

9. A system comprising:
a memory resource; and
a processing resource executing instructions stored in the memory resource to:
identify a first entity account associated with a correspondence;
determine a print profile based on the first entity account;
supplement the print profile with profile data collected from a second entity account consisting of profile data absent from the first entity account;
print a portion of the correspondence based on the supplemented print profile.

10. The system of claim 8, wherein the portion of the correspondence to print is selected from a group consisting of:
an email portion of the correspondence;
an attachment portion of the correspondence; and
the email portion and the attachment portion of the correspondence.

11. The system of claim 8, wherein the print profile includes a logical proposition generated from language of the correspondence.

12. The system of claim 8, wherein the print profile includes details about a destination to print the portion of the correspondence, and wherein the print profile further includes details about a configuration of the destination.

13. A method comprising:
identifying individual entity accounts associated with each of a plurality of correspondences;
determining a plurality of print profiles based on the individual entity accounts associated with the each of the plurality of correspondences;
categorizing the each of the plurality of correspondences into separate print profiles of the plurality of print profiles based on the individual entity accounts; and
printing the each of the plurality of correspondences based on a categorization of the each of the plurality of correspondences into separate print profiles.

14. The method of claim 13, wherein each of the separate print profiles are based on preferences data of each of the individual entity accounts.

15. The method of claim 14, wherein the preferences data of the each of the individual entity accounts is predefined.
